(19) United States
(12) Patent Application Publication
(10) Pub. No.: US 2003/0171636 A1
(43) Pub. Date: Sep. 11, 2003

(54) Global warming prevention natural state reduction recycling and energy producing technology

(76) Inventors: Ian F. Hood, Toronto (CA); Steven D. Poulos, Toronto (CA)

Correspondence Address: Ian Hood + Steven Poulos, Suite 406, 545 King Street West, Toronto, ON, M5V IMI, CA

(21) Appl. No.: 10/306,701

(22) Filed: Nov. 29, 2002

Related U.S. Application Data
(63) Continuation-in-part of application No. 10/226,333, filed on Aug. 23, 2002.
(60) Provisional application No. 60/362,442, filed on Mar. 8, 2002.

(51) Int. Cl. A62D 3/00

(52) U.S. Cl. 588/213

(57) ABSTRACT

Our process has two essential steps that convert the solid wastes into a conditioned gaseous fuel: a proprietary waste gas vessel, and a spherical fuel preparation cell. Unique aspects include a waste chute tilt at the front of the vessel complete with a surveillance system and pre-drying technology, a waste vessel key accelerant technology, 2 proprietary thermal envelopes of the vessel itself and its structural containment, and a vertically oriented recyclables and ash ejection system. All remaining fractions not converted to a gaseous fuel are automatically and completely recycled.

In a third step, the fuel is ignited, with the flared gas providing a thermal envelope for a boiler. Steam from the boiler can be utilized for any industrial purpose or steam turbine. If a boiler is not desired, it can be replaced with a reverse chiller, which will use the heat to produce refrigerated warehousing, or the waste gas can be directed to a gas turbine for the production of electricity.

The final steps combine the recovery of the small remaining amount of heat for producing hot water for greenhouse heating while cleaning and reducing the gases with proprietary lime screening, ozonation devises, and by feats of managing air temperature.

### BACKGROUND OF THE INVENTION

Gasification has been with us for more than a century, and was actually used in antiquity for various purposes including the production of charcoal. Coal gasification was used in Toronto for the lighting of streets at nights in the early 20th century and utilized in Britain as an energy source for hundreds of years. We are not inventing gasification. We are inventing the use of an energy source and creating a catalyst to use gasification in the most efficient and environmentally friendly application. Our emphasis in developing this technology is to secure a methodology to dispose of various waste types in the most environmentally friendly application possible.

Natural State Reduction and Consumable Composting (NSR/CC) is not an incineration or combustion process. Incineration and combustion processes seek to destroy waste by burning it, usually at high temperatures with some amount of excess air; the ultimate purpose of which is to burn (for the purposes of waste reduction) as much waste per unit of time as possible. Various “starved air” combusters have been designed in recent years with the primary focus of improving air emission quality over that which is achievable with conventional incineration methods, but these devices still have the ultimate view of solid waste as a non usable resource.

This past view however, misses a critical element in the environmental benefit of this process. The focus of the particular approach to converting solids into a gas described in this document is centered on the fact that municipal and industrial solid wastes (which are routinely buried at landfills) represent a significant economic resource in the form of a high Btu value non-fossil fuel product. The Btu value from this waste can approach the Btu value of natural gas when the waste gas is properly prepared in a colder process than incineration, starved of oxygen and then combusted in a system such as the one shown herein.

The secondary advantages are obvious; the environmentally responsible conversion of waste materials, virtual 100% recycling of the waste stream, and recovery for remanufacturing of all metals, glass, and minerals which compose the waste solids, liquids and sludges.

Other gasification processes that are screw fed, and sized for specific biomasses cannot accept the variety and sizes of MSW, and require expensive upfront sorting and shredding processes, and they have no simple controls over the various resulting compounds and recyclables that allow for a safe and continuous mixed waste process.

Typical gasification processes have a high temperature requirement and much higher oxygen requirements that lead to all the problems affecting the environment. The GWPT system that we have invented with all of the following modifications and built-in environmental protections operates within 800 to 1100 degrees F. and is starved of oxygen for the following reasons: in order to have incineration or combustion, oxygen is required.

Our process in varying degrees is the opposite of incineration and eliminates all of the environmental problems that incineration represents, because at no point does combustion occur. The terms of reference of our technology is Natural State Reduction whereas we speed up natures' composting process at an accelerated rate.

We are deeply concerned about what landfill represents and the emissions that are affecting the global environment. Methane off-gassing from landfill is 26 times the density of CO2 as a greenhouse gas agent. Our technology will eliminate this threat. This technology has been refined to the tenth degree so as to protect the environment and to create client interest and profit incentive for all parties involved. This is by far the most cost effective waste gasification process, and will compete with and better landfill tipping fees. This will make a very attractive investment for government and the corporate community at well below landfill costs for safe disposal methodology second to none with an additional energy profit and recyclable sales incentive. Global warming is a concern of government and corporations alike, and our technology will provide the solution that landfill global warming emissions represent.

The chutes have hydraulic doors on each end to accept and expel waste. Waste is truck-dropped into the receiving end of the chute with that end open and the conversion vessel end-doors shut. The chutes can then be tilted up and down by hydraulic pumps centered beneath the chute to roll and shuffle the waste for camera Detection and Surveillance, packing and inspection. A proprietary priming process preheats and dries the waste in the chutes using vessel waste heat via ducting and fans from the Thermal Envelope and Heat Sink (see claim 6). Each chute will take approximately 3 municipal truck loads and shuffle the waste towards the end-doors prior to emptying it into the conversion vessel.

The chutes' air circulation system primes the waste to decrease the conversion process time. This slight pre-heating and drying before entering the vessel cuts valuable supplementary fuel costs.

Hot air (125 degrees F. maximum) is introduced to the bottom of the chute and through its perforated stainless steel sides using induced fans. After 2 passes through the waste the air is exhausted via top mounted ducts at approximately 75 degrees F. or approximately 5 degrees F. above the waste's initial temperature. The superstructure of the chute is constructed of 2 irregular inverted triangle steel trusses each side of the chute with their bases as the top chords of the chute, and their apexes at approximately the center bottom of the chute where the hydraulic pump connections are located. Each chute is equipped with a small bottom trough to drain any excess moisture from the waste batch due to snow or rain.

### DETAILED DESCRIPTION OF THE INVENTION

1. Waste Chute Collector

Unsorted municipal, industrial and medical wastes, and hazardous wastes can be co-mingled in any given incoming waste load. Waste is dumped directly onto a Waste Chute Collector from the waste vehicle. The chute provides multiple advantages over direct dumping or conveyor dumping into vessels:

1. Chute allows for complete surveillance of waste via cameral, overhead crane removal of large steel items or suspect items, PCBs detection, radioactive detection via Geiger counter and tilting of waste mass to roll and reveal previously undetectable items.

2. Waste is dried on chute through perforated floor and walls using previously un-captured system waste heat. Screening options for the chute allow for waste variations such as MSW or dewatered biosolids.

Truck wheels are stopped at bumper plates just prior to chute entry. The analysis of the waste batch prior to vessel conversion is essential in today's volatile dumping activities that do not protect the public from hazardous or uncontrolled dumping. The quick detection and removal of unwanted items also preserves the integrity of the system and removes the possibility of contamination.

The chute box is rectangular in plan measuring 3 m wide×10 m×3.3 m dimensions with retractable doors at the short ends; one at the waste entry side (direct from truck) which lies horizontal in open position, and one at the vessel end that adjusts in the horizontal as it opens to the vessel entry door. The doors are 1.7 m high×3 m wide and 75 mm thick and made of stainless steel clad steel framing; the hinges are on the horizontal and the doors are hydraulically operated to close the box ends off, or to open them allowing waste in and out of the chute.

The entire box floor is formed of 127×33 steel square HSS in the longitudinal direction and is supported by 3 transverse 127×33 beams, 2 near the ends of the chute and one ⅝ of the distance to the truck dumping side. The vessel-side chute support beam is hinged while the opposite end is free to travel 55 degrees off the horizontal to chute the waste into the conversion vessel. The central transverse beam is hinged to a 100 tonne (1,000,000 N maximum allowable force) piston that lifts the free end of the chute box up (dump truck style) once the two end doors are shut into a 20 degree off-vertical position. Just prior to the lifting of the chute the 3 m×3.3 m vessel door opens and the vessel end door of the chute begins to open allowing the waste to fall into the vessel. A significant attribute of the chute design is the perforated stainless steel metal floor and walls that allows both drainage to a drying tank of many types of waste and direct drying of the waste mass by way of introducing preheated air from the pump and collection bin chambers, and the vessel perimeter plenum, and as well from the down-stream preheated air as later discussed. See drawing 11/11. This desaturating of the waste while waiting on the chute for the 12 hour preceding batch speeds up the conversion process and gains back valuable BTU energy for subsequent use. This air movement also cools the Vertical Pump Room hydraulics thereby protecting that system from overheating.

The 2 induction/forced air fans (750 mm blades) located below the chute's central axis draws the hot air from the vessel plenum through the chute sides.

The waste vessel, collection bin chamber, and vertical pump rooms are enveloped in a contiguous thermal air jacket 1 m wide that allows for the recapture of escaping radiant heat from the system and allows for a maintenance space for the various exposed exterior elements of the system. The outside wall of the envelope is a 600 mm, 25MPA, R28 insulated concrete structure that acts as both the structural containment of this underground system and a heat sink that absorbs overflow heat at maximum temperature times. This thermal mass provides a balanced supply of hot air for the use of vessel air and chute waste drying air using the structure itself to store temperatures that may or may not be called for either at times of dry waste in the chute or when no or little jacket hot air is available at batch start-up times.

2. Waste Conversion Vessels

This vessel can be of any shape and dimension, depending on site conditions and the waste volume to be processed. The standard vessel in this case is a rectangular, 12 mm thick cold rolled steel box approximately 6 m×6 m×20 m. The inside of this vessel is lined with 250 mm of mineral wool, or other insulative, non-combustible material. Over this insulation blanket, lining the vessel interior is a layer of 304 stainless steel approximately 4 mm thick. The vessel is framed in 75×33 square HSS at 600 mm O/C.

The waste chute dumps directly into the waste conversion vessel. Each cell is divided into two chambers, each holding from 40 to 60 tonnes of waste (based on a cubic yard or 0.8 cubic meters averaging 240 pounds or 110 kg, or 8 lbs per cubic foot). The weight is insignificant to the process.

Once loaded, the cell is sealed and an igniter elevates the internal temperature of the vessel chamber to 800 to 100 degrees F. Once that temperature is reached the igniters are switched off with an internal ambient oxygen percent of from 3 to 7% In this environment combustible solids, liquids and sludges will convert from that form to a heavy, BTU-rich gas vapor. This gas vapor is pulled through the remainder of the processing system by the force of and induced draft fan, found downstream at the far end of the system.

It takes roughly 12 hours for 60 tonnes of waste to convert to a gas. An additional batch of up to 60 tonnes is processed over the balance of the 24 hour day or at the same time for a 120 tonne per daysystem. Ash and recyclables are lowered into storage bins below the vessel, at the end of the process via large bottom opening doors (see section drawing). During this time the radiant heat emanating off the ash and recyclables are captured in the surrounding plenum and heat sink walls and/or water jackets provided within the 1 meter plenum space. This heat is subsequently used to dry the incoming chute waste from 25% average moisture content to approximately 10% within a 12 hour period (2 litres of evaporated water per minute)

Within the vessel an array of air and natural gas or propane supply tubes form the basis of a new heat balancing system. A computer program controls this new system of substoichiometric air and supplemental fuel to monitor and regulate the thermal composition of the waste batch creating continuity and system efficiency.

A balanced mass reduction throughout the vessel is achieved by way of key accelerants located in deficient BTU anomalies within the batch or by key decellerants (>0% stoichiometry) in overly BTU charged anomalies. Both efficiency and safety is achieved avoiding stalling and/or smoking, or conversely unnecessary ignition. These supply tubes located strategically amongst the waste batch insure maximum reduction in the shortest amount of time avoiding soft spots or hot spots without the need of expensive manual waste mixing.

These 60 mm and 9 mm respectively low oxygen and gas supply tubes (8#) run horizontally across the short span of the vessel at varying heights (see section drawings). The gas supply tubes are inserted into the air supply tubes originating from the plenum through the vessel sides.

Pulses of metered gas premixed with 80% plenum air to reduce volatility are injected into the air tubes at the vessels edge and the air carries the gas to the areas of deficiency as determined by 12 thermocouples throughout the vessel interior. Each pulse gas valve shuts off any possible blow back ignition.

Each 60 mm diameter SS tube is perforated in the bottom side by 9 mm holes @ 100 mm O/C along the tube axis, and is protected from the waste by a 72×72×33 steel angle spanning the vessel and pointing upwards toward the incoming waste direction. These steel angles are designed to break up the waste upon entry into the vessel to further expedite conversion. The sharp angles also break the fall of the waste landing on the grate to stop any damage from occurring. Make-up air is introduced into the plenum via the downstream hot air duct and mixed with plenum air.

Logic controls manifold the 8 tube dampers with the mixed radiant and downstream air supply adding air volume at 0 to 7% stoichiometry as demanded by the thermocouples sensing temperature differentials within the batch. The plenum will move a constant supply of hot air to the waste chute box for drying incoming waste prior to vessel loading. As well the ash and recyclables chamber will also supply the plenum with additional constant air.

3. Ash Bin and Recyclables Chamber

The Conversion Vessel lowers both ash and recyclables separately into two separate steel bins moving into and out of the ash and recyclables collection bin chamber below the Vessel. First, 2 swinging horizontally hinged doors open at the bottom of the vessel dropping the bottom ash directly into a 2 m high×3.7 meter wide×8 meter long steel mobile collection bin on wheels and rail guide. Second, two additional bottom grate doors in the vessel swing-down to release the remainder glass, metal and aluminum recyclables into a second collection bin. The grate is vibrated for 30 seconds by way of a proprietary clutch mechanism on the grate door motor prior to opening to insure all the ash has been separated from the recyclables. These bins remain in their chamber until their residue heating values have radiated and have been drawn back into the plenum for subsequent use during the cooler period of the new start-up batch above. Both sets of swinging doors are operated via cables and electric motors mounted on top of the vessel. The doors are shut with proprietary mineral wool and Teflon seals, and supported shut by way of a 100 tonne hydraulic pump that pushes vertically up on the door's astragal.

The pump supports both ash doors and the grate via a steel vertical tube welded to the ash doors. All doors and collection bins are fully integrated with the PLC control room, and are camera and electric eye monitored. This unique design allows for a direct and complete transfer of ash without exposure to any humanly occupied space while employing only a handful of moving parts as compared to other conveyor type transfers that often seize up due to wear and tear. The use of gravity as well to move the incoming waste through to the ash collection bin minimizes total energy outputs. The ash and recyclables bin is computer controlled to move via electric eyes to its destinations. Its upper resting position will be at grade level where the entire bin excluding its wheel mechanisms is loaded directly onto a transport for subsequent cement batching of ash and glass and bailing of metals, or stored in an ash silo for subsequent retrieval. Depending on the site the raising of the bins to grade is accomplished by way of ramp or hydraulic lift.

4. Vertical Hydraulic Pump room

This pump room houses the vertical hydraulic lift pump having a 250 mm bore and a 175 mm piston. The acting stroke is 5.1M, and the lift is calibrated to provide 3000 PSI using a 150 gallon oil reservoir. The manifold and proportional valve slow the 30 second allowable stroke time to 10 mm per second in the final approach to the closed ash doors that form the bottom of the waste conversion vessel. All pumps are fully integrated with the PLC control room. The collection bins are moved forward of the lift to provide clearance just prior to activating the pump. The lift head plate and lift guides are proprietary.

5. Waste Fuel Preparation Cell

This component is a sphere, 4 m in diameter and made from hot rolled steel 6 mm thick. It is lined with gunnite applied insulative clay, sufficient in thickness to keep the exterior surface temperature of the cell below 200 degrees F.

The raw waste gas is vented from the vessel into a sphere shaped processor, which spins the raw gas with compressed air. This process elevates the percentage of oxygen in the finished gas product from 3 to 7% up to ambient (20%). Further, the turbulence in the sphere acts as a cyclone separator that causes any fine particulate or heavy metals to fall from suspension in the gas. Ozone at 0.1 PPM is also introduced to the gas here (see section 8).

This finished fuel gas is now ready to be combusted in the primary energy system of the facility (steam boiler, hot water heater, refrigeration unit, or other such industrial processor).

6. Waste Fuel Consumption Device

This segment of the system flares the combustible processed fuel gas to produce low-cost heat for the subject industrial process (hot water heater, boiler, steam turbine, refrigeration unit, etc.) A gas turbine may be used in lieu of hot water or steam requirements where only electrical production is desired. It is a cylinder, approximately 5 m long and 2 m in diameter, with a cone on either end. This unit is also 6 mm thick hot rolled steel, with high-temp refractory liner, and exterior mineral wool shielding for exterior surface temperature control and to maximize on the heat sink provided by the refractory.

The entering gas passes though a plenum. As it exits the plenum, the gasses pass through the apex of three Maxxon pilot burners. This flares the incoming fuel with little applied supplemental fuel. The resulting fireball causes a superheated air stream of +/−1600 degrees F. The hot air exits this chamber through a restriction in the opposite conical end of the unit where the heat is exposed to the hot water element, or in the case of the attached drawings to the boiler tubes. A significant percentage of the heat in the passing hot air flow is dumped as the boiler tubes absorb the heat.

The continuing flow of the hat air now moves to a secondary heat recovery device. Usually this is in the form of a hot water heater for site or laundry use if the system is located near an institution or industrial complex. The purpose of this secondary heat reclamation process is to utilize the maximum amount of heat generated in the process and to further cool the throughput air column. Once the air passes this second step, the volume of the venting gas is significantly reduced (explanation to follow). At approximately 300 degrees F. there is still adequate thermal energy in the flowing air column to provide environmental heat for greenhouse operations or industrial workspace through radiant heat tubing. Here a portion of this heat is redirected by duct or hot water tubes to the vessel plenum as mentioned for preheated system air. Once the air has been so directed, the air temperature of the column reaching the induced draft fan surge tank is approximately 100 degrees F/. The fan further cools the gas to a given extent because of the turbulence created by the fan.

The final small air column now exits the system in a small pipe approximately 0.25 m in diameter and no more than 4 m in height.

7. Applied Science

The gasification of combustible liquids, sludges and solids is a well know event of physics. By controlling the temperature and oxygen concentration of the environment in which these combustible materials reside, the event happens spontaneously. There is no fire or flame during the process, just the conversion of form and the release of heat.

In many gasification systems there is the presence of a large exhaust stack to enable the rising process heat to be emitted from the plant by natural lift usually with exit temperatures exceeding 1200 degree F. While this is an inexpensive method of venting it wastes a great deal of the produced heat resources and the stack is objectionable to most neighbors and to the regulatory agencies.

In this process extracting as much of the available heat resources as possible eliminates the need for a stack. By the physics laws, which govern the behavior of gases, it is know that the hotter a given quantity of gas becomes the greater the area it consumes. Therefore very hot gas—say 1200 degrees F.—occupies several hundreds of times more space than that same quantity of gas at 70 degrees F. So as the process proceeds the gas loses heat AND loses volume. When the final exhaust air reaches the final system vent duct, it is basically a mixture of carbon dioxide and water vapor. Further this process of cooling the process assures a finely polished air exhaust at the end, free of pollutants, particulates and hazardous chemical compounds.

8. Lime Screening and Ozonation Devise.

Six lime screens measuring 3 meters high×1.5 meters wide×50 mm thick are enclosed in a 6 mm thick steel container having a height of 3.7 M×3.1 meters wide×2 M deep. Final stage gases are introduced into the container via four 250 mm tubes and exit in a similar fashion into the surge tank and ozonation devise (see drawings). The purpose of the lime screens are to remove the levels of hydrogen chloride and sulphur dioxides from the emission gas. This proprietary three tiered flow dampened devise is coupled to a final emission regulator on the vent stack detecting any emissions over 25 ppm of hydrogen chloride or sulphur dioxide at which time one of the three manifolds open putting into flow an appropriate volume of gas through the screens and a screen by-pass. This system preserves the lime applied to the screens for times of need only when emission guidelines are encroached upon. The detectors on the stack are to be by Teledyne, Enerac or equal gas measuring devises coupled with proprietary shut off circuitry and manifolding connected to the PLC room.

The Ozonation devise is located in the 100 cubic meter surge tank just prior to the induced draft fan and stack, and produces 0.1 PPM ozone with ultraviolet output of approximately 10,000 mW/cm. The ozone is distributed via a 200 CFM fan into the tank. Air ports are located on the side of the tank to provide both ozone make-up air and stack modified air.

Ozone is considered the “friendly oxidizer” due to the fact that it reverts back to oxygen after oxidation. Additional ozonation may be employed throughout the system. Ozone, ultraviolet light and negative ion production destroys bacteria, drops particulate to the floor of the surge tank, eliminates any smoke that may have permeated the system at start-up, disinfects the final gas release and destroys toxic fumes. The ozone production devise will be limited to 0.1 PPM and will not activate when ground level ozone is detected to be above 0.5 PPM.

9. Control Room and PLC System TBA

### BRIEF DESCRIPTION OF THE SEVERAL VIEWS OF THE DRAWING

The patent or application file contains at least one drawing executed in color. Copies of this patent or patent application publication with color drawings will be provided by the Office upon request and payment of the necessary fee.

FIG. 1. (PUBLIC VIEWING)

The System Flow Diagram depicts the general arrangement of the thru-puts and parts of the technology, and the direction of solids and gases including their temperatures as they are processed through the system. This is the preferred drawing for public viewing.

FIG. 2.

The Plan of the system details 4 chute assemblies servicing two adjacent 58 tonne vessels that empty into 4 recycling silos. The plan does not include views of the Fuel Preparation Cell and the Energy Conversion System as they are self evident in the site elevations FIG. 7 and FIG. 8.

FIG. 3.

This Section Drawing shows a back to back 4 vessel, 200 tonne per day system. A list of all of the major components are referred to on drawing 5/11. This drawing does not indicate the location of recycling/extraction silos (silo-vacs) as they are intended to be site specific. An updated version of the typical section was produces as drawing 6/11, FIG. 6.

FIG. 4.

This Part Plan shows the head of the lower hydraulic piston rod in red. This head meets up with the bottom of the ash doors to secure them in place while the vessel is fully loaded. The base of the rod shown in blue and green includes bolt locations. See FIG. 2 for actual plan location in vessel.

FIG. 5.

This drawing provides for the geometry of a wider heat sink plenum at the chute side. The center of the red circle designates the pivotal axis of the chute, and the red tipped line marks the location o the vessel door jam.

FIG. 6.

This section drawing shows the proper chute size and structure, and also indicates a possible location of the silo-vacs and recyclables retrieving. The dotted red structure above the chute is the optional crane assembly for large item retrieval.

FIG. 7.

The Site elevation shows a simplified relationship between the various parts of the vessel and lower pump rooms, and the front en of the energy conversion system. The optional silo shown accommodates a 200 tonne per day system orientation.

FIG. 8.

The energy conversion and emissions handling components are shown on this enlarged part of the site elevation, and this includes a graphic representation of a possible mini turbine.

FIG. 9 and FIG. 10.

These section details show the Grate and Ash Doors in both open and closed position, the jet action of the vacuum ejection push and pull flow, ash door seal locations, insulation locations, manifold, thermocouple, and air/gas tube locations.

FIG. 11.

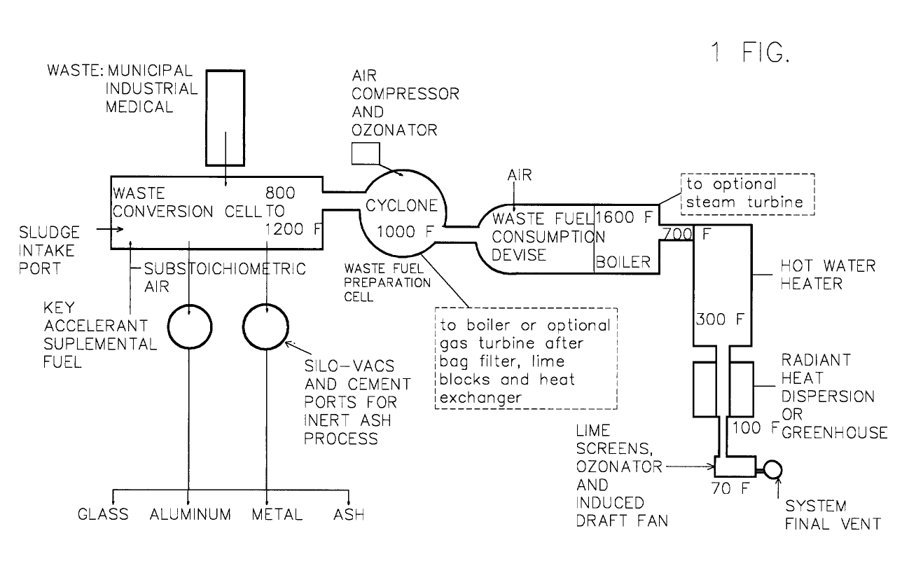

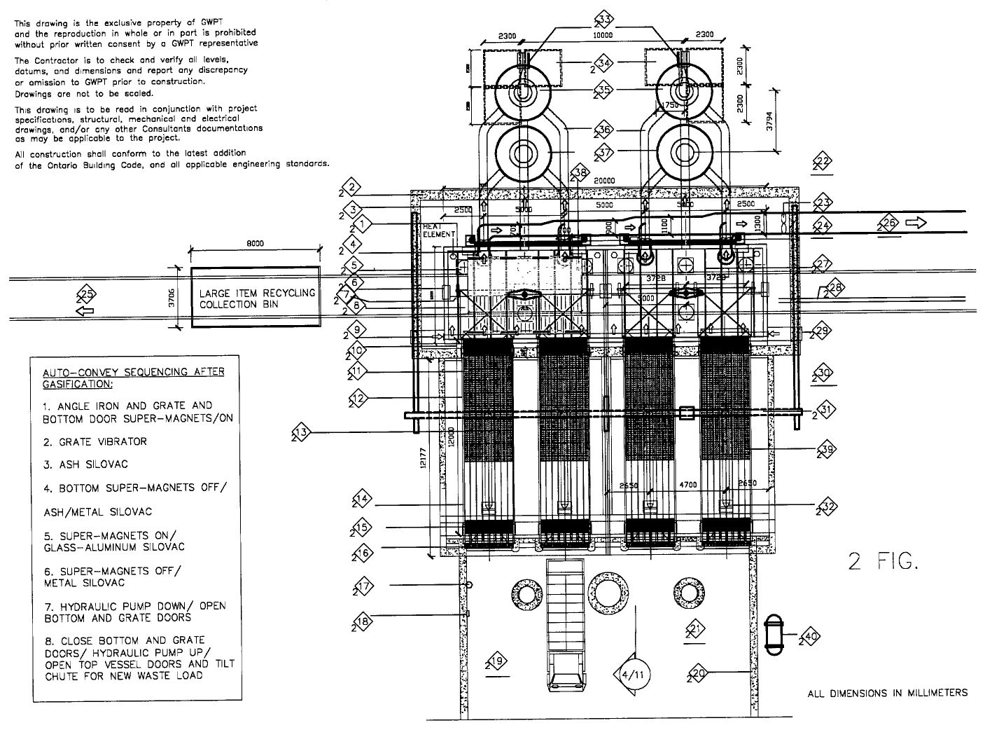

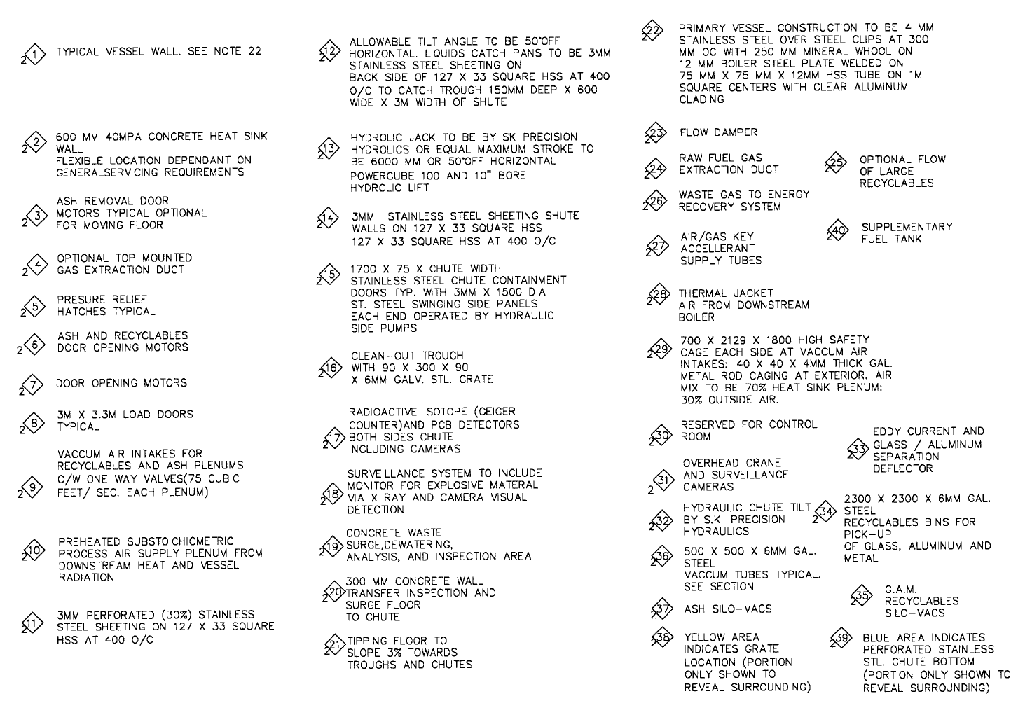

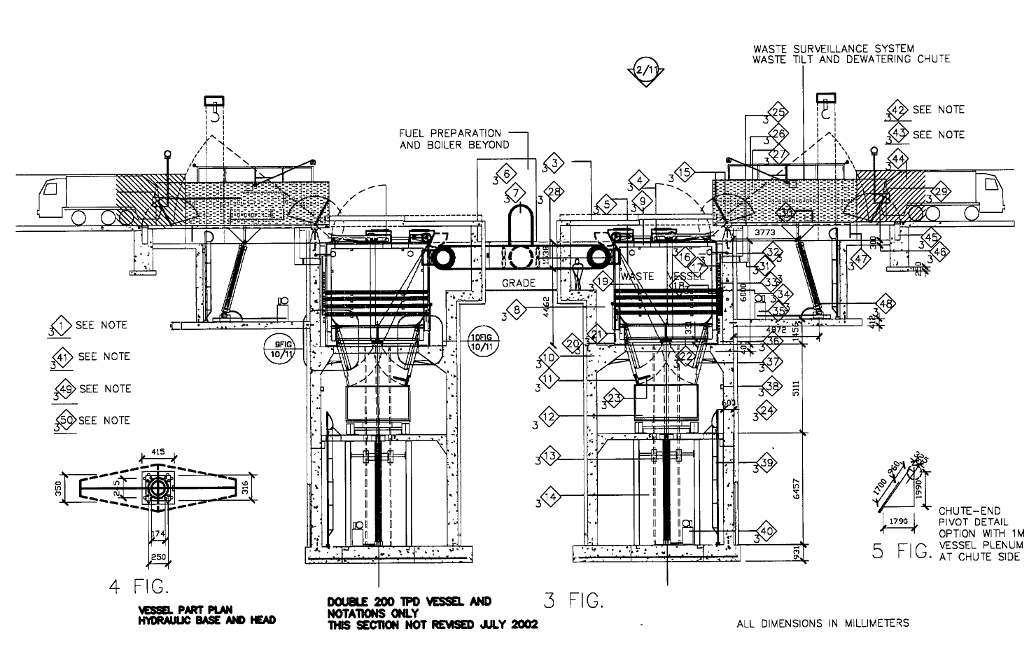

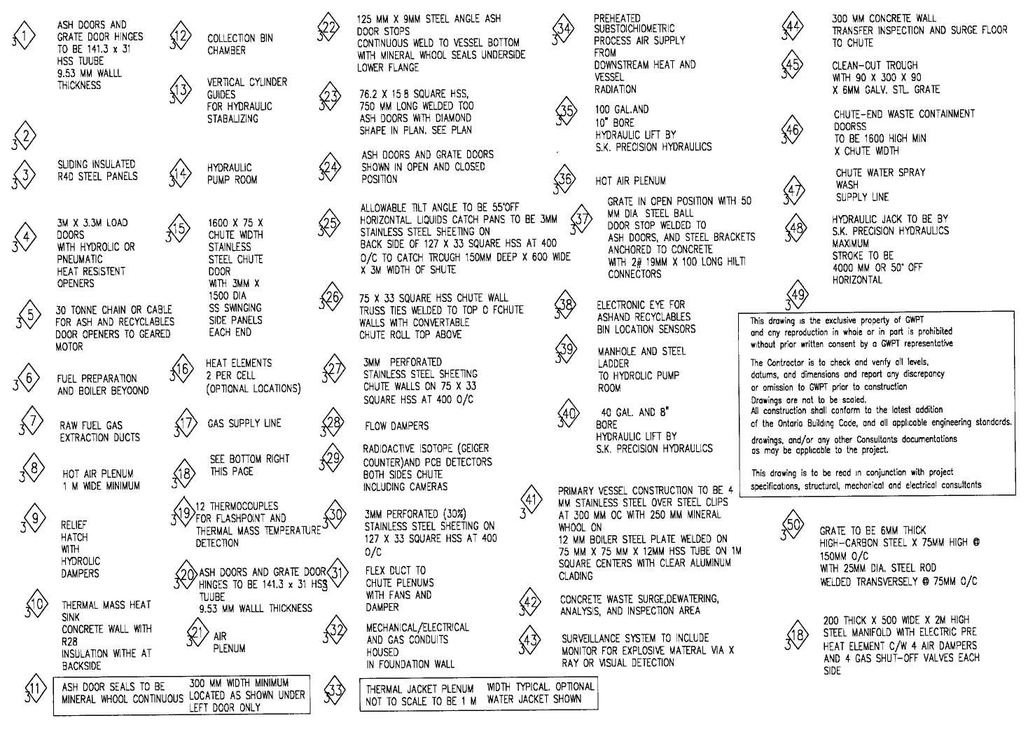

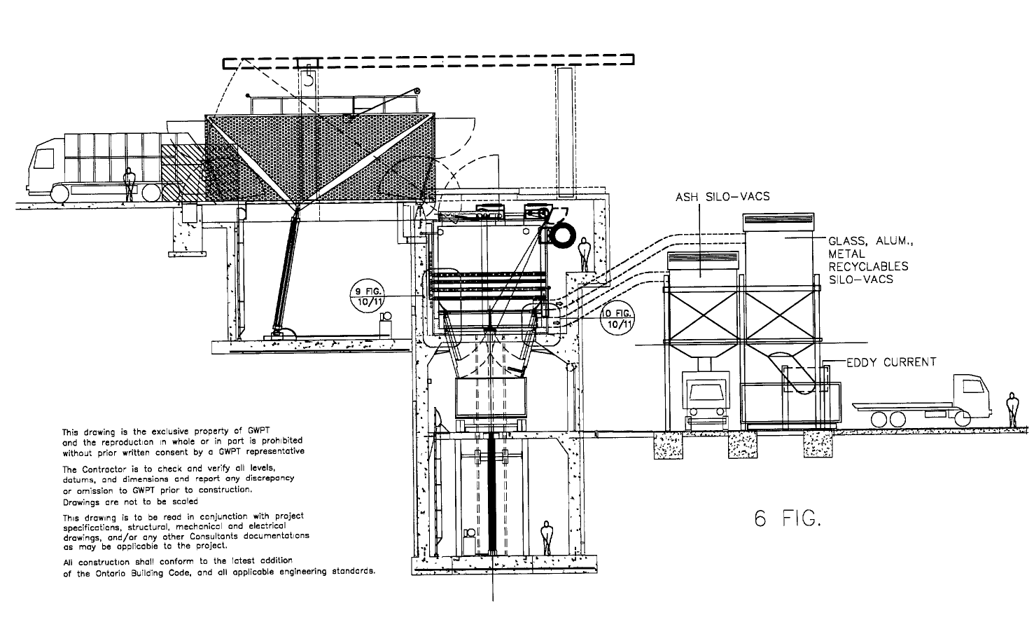

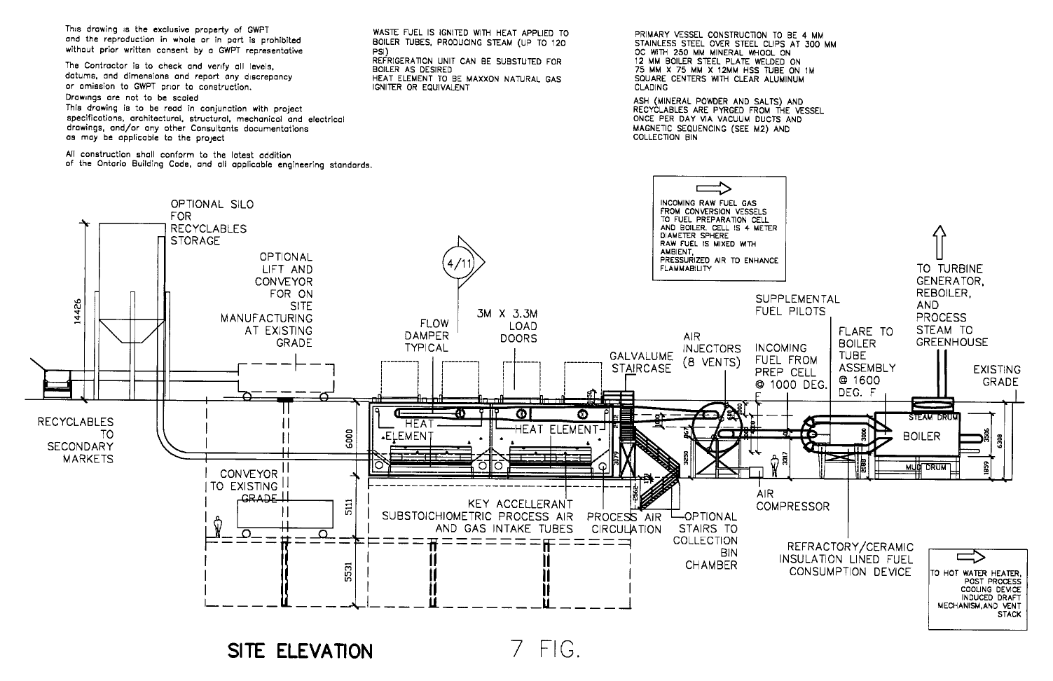

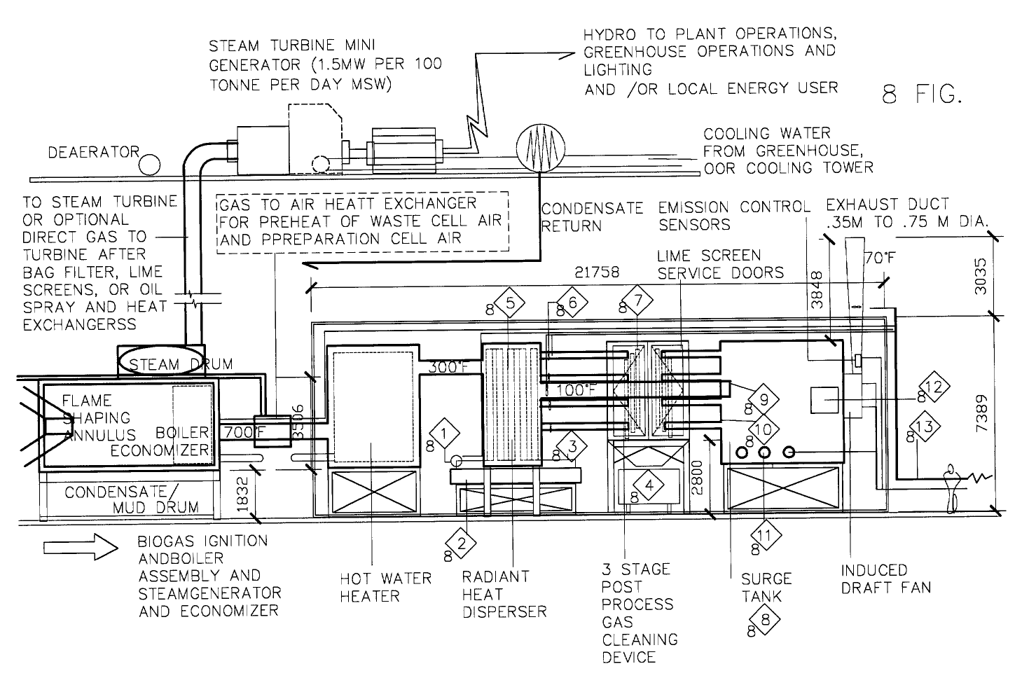

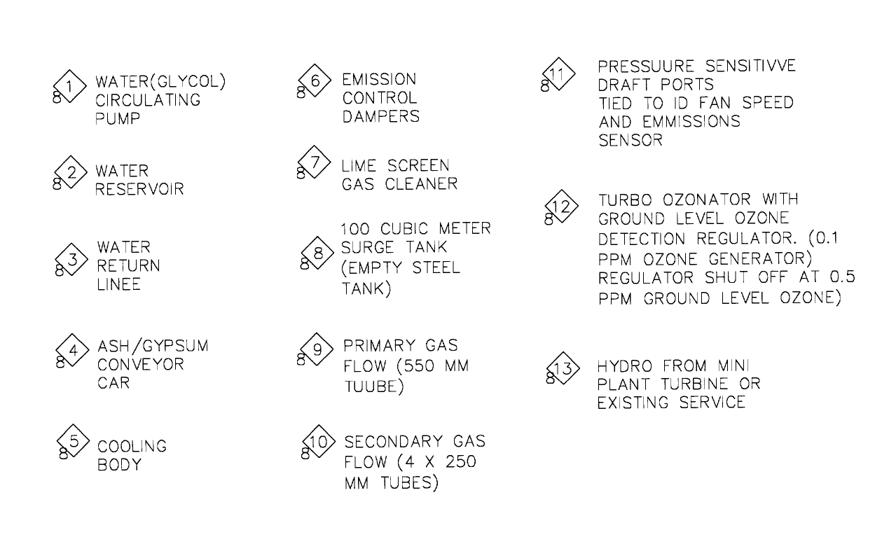

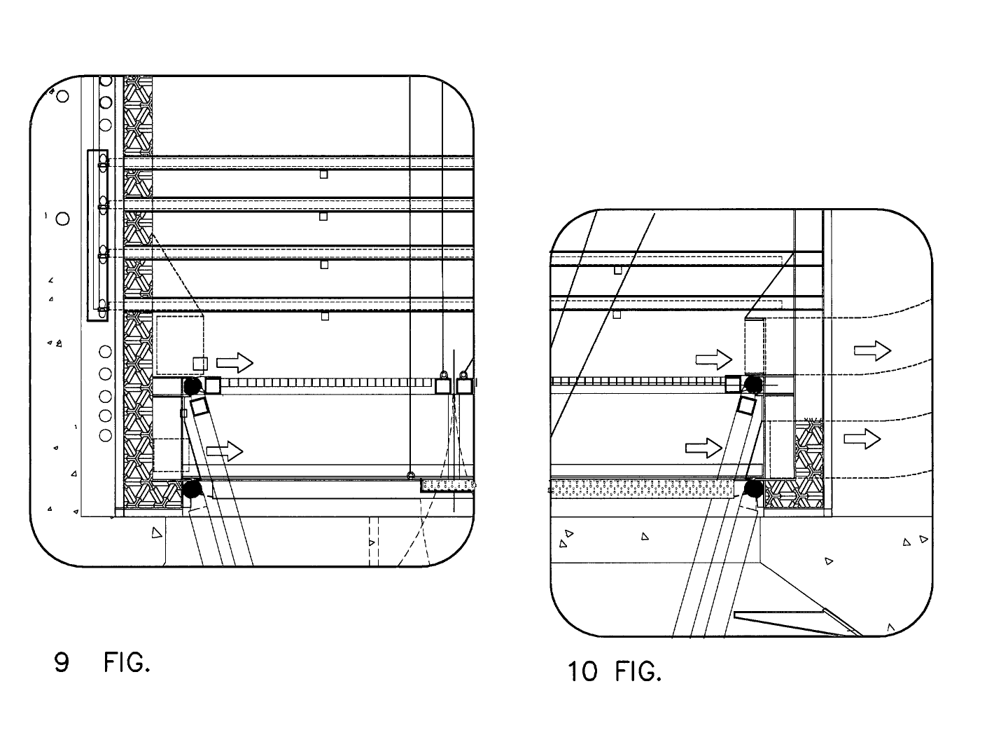

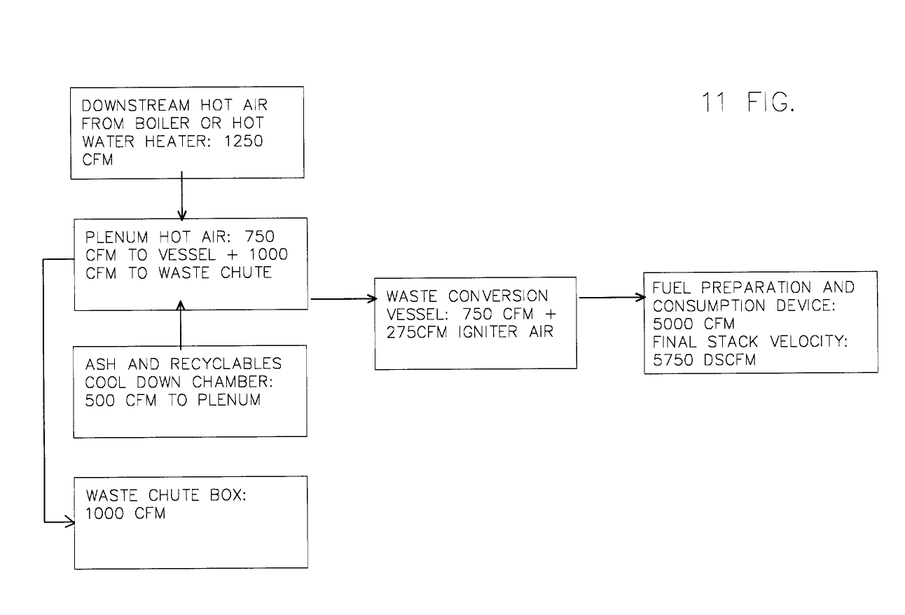

This Simplified flow diagram illustrates the possible gas volumes and their containers moving within the GWPT system.

[image]

The best use of this process is in the decentralization of the waste disposal event. As an introduction we claim that Municipal governments can save additional millions of dollars annually by eliminating the vehicles, and re-handling which current landfill practices create when wastes are accumulated in large, centralized disposal sites. However this system design is modular, and will adapt to economies of scale where appropriate epicenters allow.

The GWPT process is inexpensive to install and far less expensive to operate than landfills. Municipal governments now have a reliable tool for the final disposal of waste on a neighborhood-by-neighborhood basis at a substantial savings in the consumption of gasoline, diesel, and other fossil fuels burned in transporting wastes and lost in the industrial processes, which the waste gas will now provide at virtually no cost.

Further, there are long-term financial advantages to this type of technological replacement of land filling. The plants occupy a small, fixed site, which do not consume ever-expanding land space. The operating costs are only inflated relative to supplemental fuel and labor costs.

1. We claim that our process is unique in that our 58 Tonne per day GWPT NSR/CC (Natural State Reduction Consumable Composting) Waste Gas Conversion process has several essential steps that convert municipal solid waste (MSW) into a conditioned gaseous fuel safely and economically. The process is novel in that it accepts, gasifies and batch balances all sizes and types of waste or trash effectively for a continuous, dependable municipal process of scale. The system analyzes and prepares the waste prior to and during the process, and automatically sorts all the recyclables and resulting compounds as the vessel is preparing for the next batch. These new designs will protect the environment and the public, and will meet the new standards of the Ministry of Environment (MOE) and the EPA.
What normally took years, this system now processes in hours. This system requires no landfill and everything is recyclable and usable. The only thing that is left over is a safe environment. As well new efficiencies in this GWPT NSR/CC system reduce operating costs while extracting valuable energy at different temperatures resulting in minimal emissions that approach a zero discharge at the stack. We stand behind the above mentioned statements, and in examination we are prepared to answer all questions that are required, and we will introduce all the potential employment and energy producing merits this technology possesses.

2. The process begins as mixed waste is dropped onto our two proprietary steel Waste Chute Tilts capable of holding approximately 30 tonnes of municipal solid waste each. They are rectangular, and box-like and accept waste directly from municipal garbage trucks.
The chutes are capable of a number of automated and manual tasks including: hazardous waste detection and surveillance, packing and ballancing, preheating and drying the waste, and any number of chutes depending on the desired scale and daily tonnage of a customized waste facility may be employed.
In lieu of multiple moving parts and conveyors that prove to be costly and prone to high maintenance requirements, the chutes tilt up to 50 degrees off horizontal in 20 seconds pivoting from the end closer to the conversion vessel in the direction of its long axis similar to a dump truck..
The chutes have hydraulic doors on each end to accept and expel waste. Waste is truck-dropped into the receiving end of the chute with that end open and the conversion vessel end-doors shut. The chutes can then be tilted up and down by hydraulic pumps centered beneath the chute to roll and shuffle the waste for camera Detection and Surveillance, packing and inspection. A proprietary priming process preheats and dries the waste in the chutes using vessel waste heat via ducting and fans from the Thermal Envelope and Heat Sink (see claim 6). Each chute will take approximately 3 municipal truck loads and shuffle the waste towards the end-doors prior to emptying it into the conversion vessel.
The chutes' air circulation system primes the waste to decrease the conversion process time. This slight pre-heating and drying before entering the vessel cuts valuable supplementary fuel costs.
Hot air (125 degrees F. maximum) is introduced to the bottom of the chute and through its perforated stainless steel sides using induced fans. After 2 passes through the waste the air is exhausted via top mounted ducts at approximately 75 degrees F. or approximately 5 degrees F. above the waste's initial temperature. The superstructure of the chute is constructed of 2 irregular inverted triangle steel trusses each side of the chute with their bases as the top chords of the chute, and their apexes at approximately the center bottom of the chute where the hydraulic pump connections are located. Each chute is equipped with a small bottom trough to drain any excess moisture from the waste batch due to snow or rain.
Initial Hazardous Waste Detection and Surveillance: Geiger counters and probes will be used to identify any radioactive materials commonly found in medical waste. Hand-operated long probe Geiger counters will be used to pinpoint nuclear waste. These probes will be accommodated by 16 small hole locations with neoprene seals in the sides of the chutes. 4 primary Geiger counters will be located on the bottom of the chutes to locate the area for these probes to pinpoint contamination. This technology will not permit the serious problem of radioactive contamination getting back into the living environment. This is essential to protect the public and the worker alike and comply with all health and safety regulations, new or old. This is a feature that is absolutely necessary for any private or municipal disposal where gasification is employed. There is no other gasification process that has this feature that we have researched.

3. Our proprietary Insulated Waste Gas Vessel, with a Key Accelerant Balancing Technology prepares the batch for even consumption once tilted into the vessel. A mixed air/gas supply fed to deficient reaction areas of the batch balances the reactor as determined by thermocouples and logic controls. Over-reactive areas are deprived of all air or supplementary gases via information from the same thermocouples that determine the weak reaction areas.
This sub-stoichiometric (an internal ambient oxygen percent of from 3 to 7%) supply is fed via an Array of Horizontal Steel Tubes at various heights in the vessel each protected by an angle iron that also acts as a gravity fed bag- breaker and waste distributor in the vessel. The tubes are fed via a manifold under logic controls outside of the vessel to maintain ambient temperatures not exceeding 1100 degrees F.
These thermocouples and manifolds balance the entire 58 tonne batch to ensure an efficient, effective and safe waste-to-hydrogen process. 4 relief hatches on top of the vessels provide for emergency exhausting.
Once loaded, the cell is sealed and heater elements elevate the internal temperature of the vessel chamber. Once that temperature is reached the elements are switched off. In this environment, combustible solids, liquids and sludges will convert from that form to a heavy, BTU-rich gas vapor primarily composed of hydrogen, carbon monoxide and methane.
This gas vapor is pulled through the remainder of the processing system by the force of an induced draft fan found downstream at the far end of the system.. For the average municipal waste stream load this technology's turn-around time is approximately 12 hours depending upon the loads' content and BTU values, to complete an entire cycle of gasification, extraction, and to be in a position of reloading the vessel.
This batch tonnage cycle time has never been achieved before. Due to the pre-priming of the waste, the speed of the Waste Tilt Chute, the speed of the Key Accelerant Balancing, the Speed of the Extraction and Vacuuming Process. There is virtually no cool down time requirements between batches, no waste heat lost, and therefore a record setting conversion cycle time is produced.
These unique features that have never before been utilized in waste gasification are the technologies we represent. In conjunction with the logic controls for these features this is the most economically viable, cost effective, environmentally friendly Natural State Reduction Technology ever invented.

4. Our proprietary Fuel Preparation Cell is a large steel spherical container surrounded by air jet injectors that will pre-oxygenate the resultant waste gas before subsequent energy conversion and remove particulate via cyclonic action.

5. Extraction and Vacuuming Process. At the end of the process when the logic controls indicate the gasification values have been depleted the following proprietary automated tasks take place to evacuate and separate the recyclable contents of the cell:
1. Super magnetization of the grate and the angle irons, and the bottom vessel doors hold all ferrous metals in place. 2. The grate vibrator is activated to loosen and release any ash to the bottom of the vessel. 3. The Ash Silo-Vac activates to extract from the vessel via 3 vacuum ports all accumulated inert ash and any other particulates deposited below the grate through the sifting process. 4. Once the ash vacuum system logic controls light sensors detect no further extraction from the vessel the ash vacuum system shuts down and closes, then bottom
2. metal is removed via ash vacuum port #2 valve after bottom magnets turned off. 5. Secondary vacuum systems are activated above the grate and all other matter not held by super magnets are now extracted by the secondary silo-vac via 3 other vacuum ports. 6. Once the secondary vacuum system logic controls light sensors detect no further extraction from the vessel of non- ferrous material the secondary vacuum system completes the process whereas the super magnets are deactivated and all remaining metals that can be removed by the vacuum system are extracted and separated from the preceding extraction of non-ferrous material via a duct valve mechanism leading to a different container. 7. For all other matter left in the cell after the vacuum system processes have been completed, logic controls then activate the bottom hydraulic pump to be lowered and a heavy materials bin is mechanically positioned below the vessel not unlike a car wash chain system. The heavy material bin will have rubber tires, and these bins will return to the starting position outside the vessel via a reverse chain gear. There is video camera surveillance activated at all times to detect any possible malfunction by mechanical breakdown or operator error. At the end of the bin cycle all materials are removed for recycling. 8. Logic controls close the bottom doors, and the hydraulic pump and grates and upon the command of the operator the vessel is refilled to once again process waste materials via the top vessel doors and the waste tilt chute.

6. Two proprietary Thermal Envelopes of the vessel itself and its structural containment become essential and basic requirements for temperature balancing and pre-drying of the waste batch in order to generate a maximum efficiency rating of the fuel. The outside concrete thermal envelope also acts as a heat sink and protection barrier, and is also established to comply with,and exceed all health and safety regulations mandated by the Ontario Government where potential hazardous waste applies. This insulated concrete envelope combined with 4 relief hatches per cell provides a high level of safety and responsible protection of Municipal employees. The vessel envelope itself is primarily a mineral wool insulation barrier. During the gasification cycle the radiant heat emanating from the surrounding plenum and heat sink walls is subsequently used to dry the incoming chute waste as discussed in claim #2.

7. The silo systems that are in a direct feed from the vessels are used as a depository for recyclables. These silos are not a part of the invention but act as depository and containment values that are mandatory to comply with the MOE. They provide for a_zero-exposure environment_that prevents any occurrence of airborne substances of final ash and recyclables. Potential to create a cement batching operation with the inert ash materials along with pulverized glass is available, and separate from this invention. This will depend upon the needs of the client and his desire to do so.

8. NSRS CC dual hot water recovery system: hot water at any temperature can be used to meet sludge biosolids drying requirements or for greenhouse heating or for other potential users that the client may require to fulfill his needs as far as the end energy use produced by this technology. Because of these multiple heat dispersion modules an extraordinarily small volume of exhaust air results due to a feat of managing air temperature and extracting the maximum BTUs in the process heat as possible. The net result of this eliminates any meaningful exhaust air.
Also it is virtually free of any pollutants because of the monitoring prior to the waste conversion process. Any remaining fractions are completely recyclable. The environment must be protected and this process will ensure that all that is possible to protect any form of contamination of the environment will be implemented.

9. Proprietary Lime Screening and Ozonation Devises as the drawings indicate form part of the pollution control mechanisms that are controlled by the monitoring systems to maintain absolute understandings of atmospheric venting. A valve redirecting non-complying MOE standards for exhaust back through the lime and ozonation process until such time as compliance has been achieved will ensure a zero tolerance system. System controls will not tolerate contamination of the atmosphere.

10. This system represents the state of the art technology in Natural State Reduction Conversion of solid waste, biosolids and hazardous waste solutions. This is an environmentally friendly industry and community cutting edge technology. Municipalities and industry will desire the system because of its profit incentives and its unique qualities in dealing with their waste management problems, and the environmental green plus that it represents. This technology demonstrates the change in emphasis from landfill that poisons the environment to a Natural State Reduction technology that protects it without incineration.
